(19) United States
(12) Patent Application Publication
(10) Pub. No.: US 2020/0282599 A1
(43) Pub. Date: Sep. 10, 2020

(54) SCREW DESIGNS FOR USE WHEN MOLDING PRODUCTS THAT INCLUDE SHEER SENSITIVE MATERIALS

(71) Applicant: INTEGRATED COMPOSITE PRODUCTS, INC., Rochester, MN (US)

(72) Inventors: Ronald Clare Hawley, Winona, MN (US); Robert John Wick, Rushford, MN (US)

(73) Assignee: INTEGRATED COMPOSITE PRODUCTS, INC., Rochester, MN (US)

(21) Appl. No.: 16/807,681

(22) Filed: Mar. 3, 2020

Related U.S. Application Data
(60) Provisional application No. 62/813,338, filed on Mar. 4, 2019.

(51) Int. Cl. B29B 7/42; B29B 7/90

(52) U.S. Cl. CPC B29B 7/421; B29K 2101/12; B29B 7/90

(57) ABSTRACT

Systems for molding products that include sheer sensitive materials are disclosed. The systems may include a barrel. A hopper may be in communication with the barrel. A screw may be disposed within the barrel. The screw may be designed to rotate and reciprocate within the barrel. The screw may include a metering section. A plurality of dome members may be coupled to the screw and disposed along the metering section.

### CROSS-REFERENCE TO RELATED APPLICATIONS

This application claims priority to U.S. Provisional Application Ser. No. 62/813,338, filed Mar. 4, 2019, the entirety of which is incorporated herein by reference.

### TECHNICAL FIELD

The present disclosure pertains to devices and methods for manufacturing products. More particularly, the present disclosure pertains to screw designs for use when molding products that include sheer sensitive materials.

### BACKGROUND

A wide variety of devices for molding products, as well as methods for molding products, have been developed. Of the known devices and methods, each has certain advantages and disadvantages. There is an ongoing need to provide alternative devices as well as alternative methods for molding products.

### BRIEF SUMMARY

This disclosure provides design, material, manufacturing method, and use alternatives for devices for molding products. A system for molding products that include long fiber thermoplastic materials is disclosed. The system comprises: a barrel; a hopper in communication with the barrel; a screw disposed within the barrel, the screw being designed to rotate and reciprocate within the barrel; wherein the screw includes a metering section; and a plurality of dome members coupled to the screw and disposed along the metering section.

Alternatively or additionally to any of the embodiments above, the screw includes a root and a helical thread disposed about the root.

Alternatively or additionally to any of the embodiments above, at least some of the plurality of dome members are disposed between adjacent windings of the helical thread.

Alternatively or additionally to any of the embodiments above, at least some of the plurality of dome members are disposed symmetrically relative to the helical thread.

Alternatively or additionally to any of the embodiments above, at least some of the plurality of dome members are positioned midway between adjacent windings of the helical thread.

Alternatively or additionally to any of the embodiments above, at least some of the plurality of dome members are disposed asymmetrically relative to the helical thread.

Alternatively or additionally to any of the embodiments above, the helical thread includes a first winding and a second winding adjacent to the first winding, wherein the first winding includes a first edge facing downstream, wherein the second winding includes a second edge facing upstream, and wherein at least some of the plurality of dome members are disposed closer to the first edge than to the second edge.

Alternatively or additionally to any of the embodiments above, the root has a first root diameter at the metering section and a second root diameter at a feed region, the second root diameter being different than the first root diameter.

Alternatively or additionally to any of the embodiments above, the helical thread projects a first distance radially outward from the root, wherein at least some of the plurality of dome members project a second distance radially outward from the root, and wherein the first distance is greater than the second distance.

Alternatively or additionally to any of the embodiments above, the screw is free of helical thread.

Alternatively or additionally to any of the embodiments above, the screw includes a broken helical thread.

Alternatively or additionally to any of the embodiments above, the screw includes a discontinuous helical thread.

Alternatively or additionally to any of the embodiments above, the screw includes a broken thread.

Alternatively or additionally to any of the embodiments above, the screw includes a discontinuous thread.

Alternatively or additionally to any of the embodiments above, the screw is designed to translate within the barrel.

Alternatively or additionally to any of the embodiments above, the screw includes a feed section and a transition section.

Alternatively or additionally to any of the embodiments above, further comprising one or more additional dome members disposed along the feed section.

Alternatively or additionally to any of the embodiments above, the feed section is free of dome members.

Alternatively or additionally to any of the embodiments above, further comprising one or more additional dome members disposed along the transition section.

Alternatively or additionally to any of the embodiments above, the transition section is free of dome members.

Alternatively or additionally to any of the embodiments above, further comprising one or more additional dome members disposed along the feed section and one or more additional dome members disposed along the transition section.

Alternatively or additionally to any of the embodiments above, the feed section is free of dome members and the transition section is free of dome members.

A system for molding products that include long fiber thermoplastic materials is disclosed. The system comprises: a barrel; a hopper in communication with the barrel; a screw disposed within the barrel, the screw being designed to rotate and translate within the barrel; wherein the screw includes a metering section; and a plurality of dome members coupled to the screw and disposed along the metering section.

Alternatively or additionally to any of the embodiments above, the screw includes a root and a helical thread disposed about the root.

Alternatively or additionally to any of the embodiments above, at least some of the plurality of dome members are disposed between adjacent windings of the helical thread.

Alternatively or additionally to any of the embodiments above, at least some of the plurality of dome members are disposed symmetrically relative to the helical thread.

Alternatively or additionally to any of the embodiments above, at least some of the plurality of dome members are positioned midway between adjacent windings of the helical thread.

Alternatively or additionally to any of the embodiments above, at least some of the plurality of dome members are disposed asymmetrically relative to the helical thread.

Alternatively or additionally to any of the embodiments above, the helical thread includes a first winding and a second winding adjacent to the first winding, wherein the first winding includes a first edge facing downstream, wherein the second winding includes a second edge facing upstream, and wherein at least some of the plurality of dome members are disposed closer to the first edge than to the second edge.

Alternatively or additionally to any of the embodiments above, the root has a first root diameter at the metering section and a second root diameter at a feed region, the second root diameter being different than the first root diameter.

Alternatively or additionally to any of the embodiments above, the helical thread projects a first distance radially outward from the root, wherein at least some of the plurality of dome members project a second distance radially outward from the root, and wherein the first distance is greater than the second distance.

Alternatively or additionally to any of the embodiments above, the screw is free of helical thread.

Alternatively or additionally to any of the embodiments above, the screw includes a broken helical thread.

Alternatively or additionally to any of the embodiments above, the screw includes a discontinuous helical thread.

Alternatively or additionally to any of the embodiments above, the screw includes a broken thread.

Alternatively or additionally to any of the embodiments above, the screw includes a discontinuous thread.

Alternatively or additionally to any of the embodiments above, the screw is designed to reciprocate within the barrel.

Alternatively or additionally to any of the embodiments above, the screw includes a feed section and a transition section.

Alternatively or additionally to any of the embodiments above, further comprising one or more additional dome members disposed along the feed section.

Alternatively or additionally to any of the embodiments above, the feed section is free of dome members.

Alternatively or additionally to any of the embodiments above, further comprising one or more additional dome members disposed along the transition section.

Alternatively or additionally to any of the embodiments above, the transition section is free of dome members.

Alternatively or additionally to any of the embodiments above, further comprising one or more additional dome members disposed along the feed section and one or more additional dome members disposed along the transition section.

Alternatively or additionally to any of the embodiments above, the feed section is free of dome members and the transition section is free of dome members.

A system for molding products that include long fiber thermoplastic materials is disclosed. The system comprises: a barrel; a hopper in communication with the barrel; a screw disposed within the barrel, the screw being designed to rotate and translate/reciprocate within the barrel; wherein the screw includes a metering section; and a plurality of dome members coupled to the screw and disposed along the metering section.

A system for molding products that include long fiber thermoplastic materials is disclosed. The system comprises: a barrel; a hopper in communication with the barrel; a screw disposed within the barrel, the screw including a screw root and a helical flight disposed about the screw root; wherein the screw is designed to rotate and reciprocate within the barrel; wherein the screw includes a feed zone, a transition zone, and a metering zone; and a plurality of dome members coupled to the screw and disposed along the metering zone.

Alternatively or additionally to any of the embodiments above, at least some of the plurality of dome members are disposed between adjacent windings of the helical flight.

Alternatively or additionally to any of the embodiments above, at least some of the plurality of dome members are positioned midway between adjacent windings of the helical flight.

Alternatively or additionally to any of the embodiments above, the helical flight includes a first winding and a second winding adjacent to the first winding, wherein the first winding includes a first edge facing downstream, wherein the second winding includes a second edge facing upstream, and wherein at least some of the plurality of dome members are disposed closer to the first edge than to the second edge.

Alternatively or additionally to any of the embodiments above, the screw root has a first root diameter at the metering zone and a second root diameter at the feed zone, the second root diameter being different than the first root diameter.

Alternatively or additionally to any of the embodiments above, the helical flight projects a first distance radially outward from the screw root, wherein at least some of the plurality of dome members project a second distance radially outward from the screw root, and wherein the first distance is greater than the second distance.

Alternatively or additionally to any of the embodiments above, further comprising one or more additional dome members disposed along the feed zone.

Alternatively or additionally to any of the embodiments above, the feed zone is free of dome members.

Alternatively or additionally to any of the embodiments above, further comprising one or more additional dome members disposed along the transition zone.

Alternatively or additionally to any of the embodiments above, the transition zone is free of dome members.

Alternatively or additionally to any of the embodiments above, further comprising one or more additional dome members disposed along the feed zone and one or more additional dome members disposed along the transition zone.

Alternatively or additionally to any of the embodiments above, the feed zone is free of dome members and the transition zone is free of dome members.

A system for molding products is disclosed. The system comprises: a barrel containing a resin and a plurality of fibers; wherein the resin includes a thermoplastic resin; wherein at least some of the plurality of fibers include fibers having a length of at least 6 millimeters; a screw disposed within the barrel, the screw including a screw root and a helical flight disposed about the screw root; wherein the screw is designed to rotate and reciprocate within the barrel; wherein the screw includes a feed zone, a transition zone, and a metering zone; and a plurality of dome members coupled to the screw and disposed along the metering zone.

Alternatively or additionally to any of the embodiments above, further comprising a die coupled to the barrel.

Alternatively or additionally to any of the embodiments above, further comprising a molding apparatus coupled to the die.

Alternatively or additionally to any of the embodiments above, wherein at least some of the plurality of fibers include fibers having a length of at least 7 millimeters.

Alternatively or additionally to any of the embodiments above, at least some of the plurality of fibers include fibers having a length of at least 8 millimeters.

Alternatively or additionally to any of the embodiments above, at least some of the plurality of fibers include fibers having a length of at least 9 millimeters.

Alternatively or additionally to any of the embodiments above, at least some of the plurality of fibers include fibers having a length of at least 10 millimeters.

Alternatively or additionally to any of the embodiments above, at least some of the plurality of fibers include fibers having a length of at least 11 millimeters.

Alternatively or additionally to any of the embodiments above, at least some of the plurality of fibers include fibers having a length of at least 12 millimeters.

Alternatively or additionally to any of the embodiments above, at least some of the plurality of fibers include fibers having a length of about 6-12 millimeters.

Alternatively or additionally to any of the embodiments above, at least some of the plurality of fibers include fibers having a length of about 8-12 millimeters.

Alternatively or additionally to any of the embodiments above, at least some of the plurality of fibers include fibers having a length of about 10-12 millimeters.

Alternatively or additionally to any of the embodiments above, at least some of the plurality of fibers include fibers having a length of about 8-10 millimeters.

Alternatively or additionally to any of the embodiments above, a molded product formed by any of the systems above is disclosed.

A molded product is disclosed. The molded product comprises: a thermoplastic resin; and a plurality of fibers having a length of at least 6 millimeters.

A molded product is disclosed. The molded product comprises: a thermoplastic resin; and a plurality of fibers having a length of at least 8 millimeters.

A molded product is disclosed. The molded product comprises: a thermoplastic resin; and a plurality of fibers having a length of at least 10 millimeters.

A molded product is disclosed. The molded product comprises: a thermoplastic resin; and a plurality of fibers having a length of at least 12 millimeters.

A system for molding products that include sheer sensitive materials is disclosed. The system comprises: a barrel; a hopper in communication with the barrel; a screw disposed within the barrel, the screw being designed to rotate and reciprocate within the barrel; wherein the screw includes a metering section; and a plurality of dome members coupled to the screw and disposed along the metering section.

The above summary of some embodiments is not intended to describe each disclosed embodiment or every implementation of the present disclosure. The Figures, and Detailed Description, which follow, more particularly exemplify these embodiments.

### BRIEF DESCRIPTION OF THE DRAWINGS

The disclosure may be more completely understood in consideration of the following detailed description in connection with the accompanying drawings, in which:

FIG. 1 is schematic overview of an example compression molding system.

FIG. 2 is schematic overview of an example injection molding system.

FIG. 3 is a schematic representation of a portion of an example system and depicts an example screw that can be used with a molding system.

FIG. 4 is a side view of a portion of an example screw and depicting dome members.

FIG. 5 is a side view of a portion an example screw with example dome members.

FIG. 6 is a side view of a portion an example screw with example dome members.

FIG. 7 is a side view of a portion an example screw with example dome members.

FIG. 8 depicts a single example dome member.

While the disclosure is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used connection with other embodiments whether or not explicitly described unless clearly stated to the contrary.

The following detailed description should be read with reference to the drawings in which similar elements in different drawings are numbered the same. The drawings, which are not necessarily to scale, depict illustrative embodiments and are not intended to limit the scope of the invention.

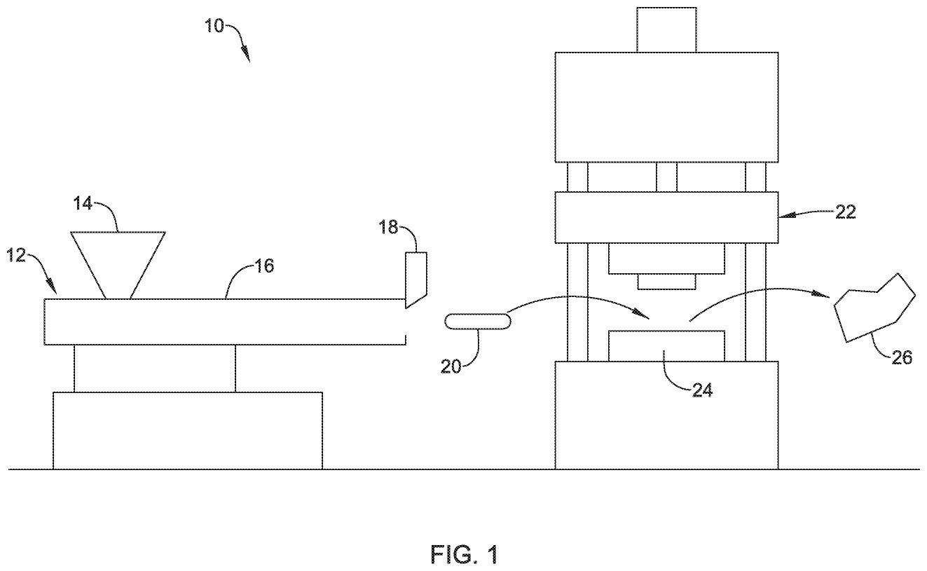

FIG. 1 schematically depicts a system 10 (e.g., a compression molding system) for forming products. The system 10 may include a melting and mixing apparatus 12. The melting and mixing apparatus 12 may include a hopper 14, a barrel 16, and a blade 18. In this example, a pre-form part 20 may be produced by the melting and mixing apparatus 12 and the pre-form part 20 may be further molded using a compression molding apparatus 22. When doing so, the pre-form part 20 may be disposed within a mold cavity 24 of the compression molding apparatus 22 in order to form the finished part 26.

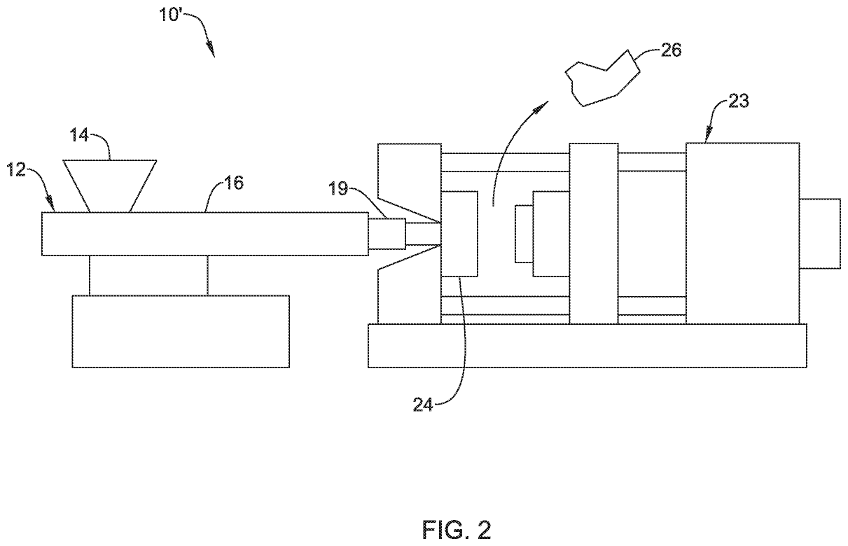

FIG. 2 schematically depicts a system 10′ (e.g., an injection molding system) for forming products. The system 10′ may include a melting and mixing apparatus 12. The melting and mixing apparatus 12 may include a hopper 14, a barrel 16, and a nozzle and/or die 19. In this example, material passing through the melting and mixing apparatus 12 may pass through or otherwise be injected into an injection molding apparatus 23 (e.g., a molding cavity 24 of the injection molding apparatus 23) in order to form the finished part 26.

In some instances, it may be desirable to provide a finished part, such as the finished part 26 formed by the systems 10/10′, with a structural reinforcement. For example, it may be desirable to reinforce molded parts with glass fibers and/or fiber reinforcements. In general, glass fibers having a longer fiber length provide greater structural reinforcement. Thus, when molding parts with fiber reinforcements, it may be desirable for the fibers to have a relatively long fiber length. In addition, fiber reinforcements and other materials may be described as being sheer sensitive. For the purposes of this disclosure, sheer sensitive materials may be understood to be materials that can break, sever, and/or otherwise be disrupted when exposed to sheer forces such as those sheer forces commonly present in a melting and mixing apparatus. It may be desirable to provide a finished part that includes sheer sensitive materials and, for example, to provide the finished part in which the sheer sensitive materials are less and/or minimally disrupted.

Molding parts with fibers reinforcements, along with suitable resin material(s), may include adding the fibers to the hopper 14 and/or barrel 16 of the melting and mixing apparatus 12. When undergoing the melting and mixing process, sheer forces within the barrel 16 can break, sever, or otherwise reduce the fiber length of the fiber reinforcement. Disclosed herein are systems that are designed to all products to be formed/molded with fiber reinforcements with a relatively long fiber length. For example, the systems disclosed herein may be suitable for forming/molding products with fiber reinforcements in which the fibers have a length of at least 6 millimeters, have a length of at least 7 millimeters, have a length of at least 8 millimeters, have a length of at least 9 millimeters, have a length of at least 10 millimeters, have a length of at least 11 millimeters, have a length of at least 12 millimeters, have a length of 6-12 millimeters, have a length of 6-50 millimeters, have a length of 8-12 millimeters, have a length of 10-12 millimeters, have a length of 8-10 millimeters, or the like. In addition, the systems disclosed herein may be suitable for forming/molding products that include sheer sensitive materials (e.g., fiber material, glass fibers, long fiber thermoplastic materials, sheer sensitive resins, polyvinyl chloride, acetals, sheer sensitive additives, and/or the like) in a manner such that the sheer sensitive materials are less and/or minimally disrupted.

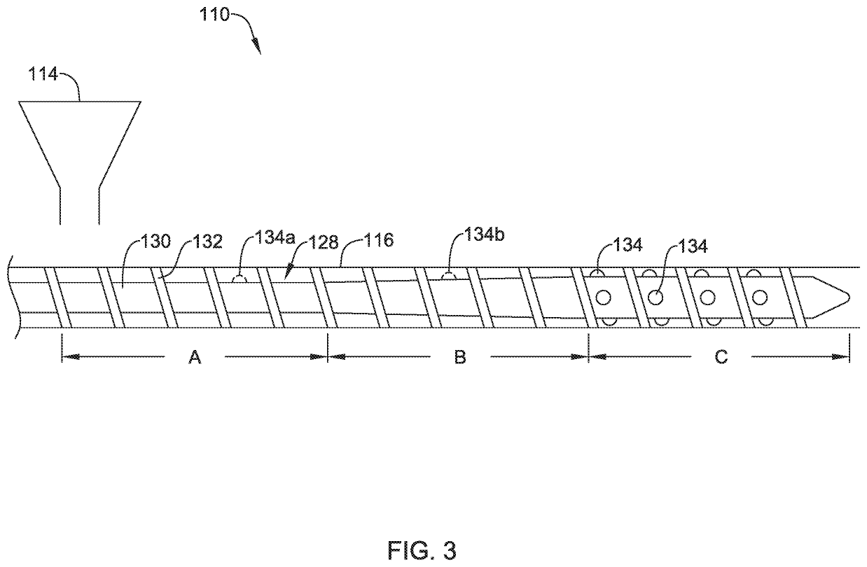

A portion of an example system 110 for forming/molding products with long fiber reinforcements (e.g., long fiber thermoplastic materials) and/or sheer sensitive materials is depicted in FIG. 3. The system 110 may be part of and/or otherwise take the form of an extrusion system, a molding system, a compression molding system (e.g., similar to the compression molding system 10), an injection molding system (e.g., similar to the compression molding system 10′), and/or the like. For example, the system 110 may include a hopper 114 and a barrel 116. A screw 128 may be disposed within the barrel 116. The screw 128 is generally designed to rotate within the barrel 116. In addition, the screw 128 may also be designed to translate and/or reciprocate within the barrel 116. The screw 128 may include a screw root 130 and a helical thread or flight 132. The screw 128 may include a first region or zone A, a second region or zone B, and a third region or zone C. The first zone A may be understood to be a feed zone A, the second zone B may be understood to be a transition zone B, and the third zone C may be understood to be a metering zone C. These are just examples.

In some instances, the screw root 130 may have or define a root diameter. The root diameter may be constant along the length of the screw root 130. In other instances, the root diameter may vary in diameter. For example, the screw root 130 may have a first root diameter along the feed zone A. The root diameter may increase in diameter along the transition zone B. The screw root 130 may have a second root diameter along the metering zone C. The second root diameter may be greater than the first root diameter.

The helical thread or flight 132 may also vary in form. In some instances, the thread 132 may extend helically about the screw root 130 in a regular manner and with a constant pitch. In other instances, the pitch may vary. In still other instances, the thread 132 need not be arranged as a helix and may include sections or regions that extend radially and/or axially, rather than helically. In some instances, the thread 132 may be continuous. In other words, the thread 132 may be a singular structure that extends continuously along the screw root 130. In other instances, the thread 132 may be broken, interrupted, and/or otherwise discontinuous. In other words, the thread 132 may include a plurality of discrete sections or segments that are spaced apart from one another.

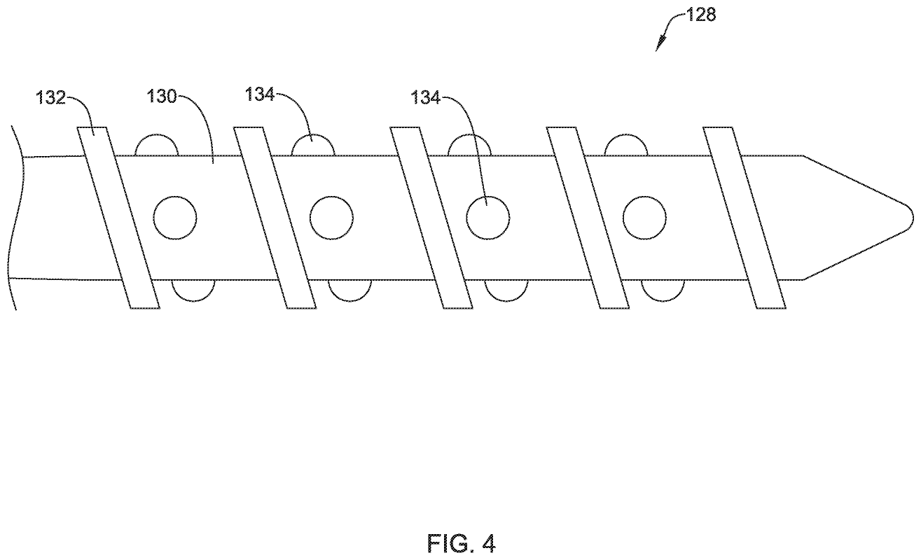

As shown in FIG. 3 and in FIG. 4, a plurality of dome members 134 may be disposed along the screw 128. In general, material (e.g., resin material) disposed in the barrel 116 and/or adjacent to the screw 128 can be melted and form a thoroughly mixed homogenous melt. As the material reaches the metering zone C, the melted resin materials may be mixed with sheer sensitive materials that are present in the barrel 116 along with the resin material. It may be desirable to mix the resin material with sheer sensitive materials (e.g., fiber material, glass fibers, long fiber thermoplastic materials, sheer sensitive resins, polyvinyl chloride, acetals, sheer sensitive additives, and/or the like) in a manner that helps to reduce/minimize disruption, breaking, severing, and/or the like of the sheer sensitive materials. The dome members 134 may be designed to help reduce sheer forces on the sheer sensitive materials and, thus, reduce/minimize disruption, breaking, severing, and/or the like of the sheer sensitive materials. For example, the dome members 134 may be useful when forming products with long fiber thermoplastic materials. When mixing the melted resin with long fiber thermoplastic materials, the dome members may help to gently stir and/or mix the melted resin with the long fiber thermoplastic materials so that the fiber length can be kept relatively long. Some examples of suitable long fiber thermoplastic materials may include those disclosed in U.S. Pat. Nos. 10,016,953, 10,195,818, and 10,086,571, then entire disclosures of which are herein incorporated by reference. Other sheer sensitive materials are contemplated including sheer sensitive resins, polyvinyl chloride, acetals, sheer sensitive additives, and/or the like. It may also be desirable to gently stir and/or mix the melted resin with these and other materials (e.g., additives, fire retardants, colorants, and/or the like). The dome members 134 may be suitable for gently stirring and/or mixing such materials.

The dome members 134 may take the form of rounded projections that extend radially from the screw root 130. In at least some instances, the dome members 134 may have a rounded profile and/or resemble a rounded dome that could be described as being hemispherical. However, the dome members 134 need not have such a shape. For example, the dome members 134 may have a generally rounded or tapering shape. Alternatively, the dome members 134 may have an oval shape, a polygonal shape, or any other suitable shape.

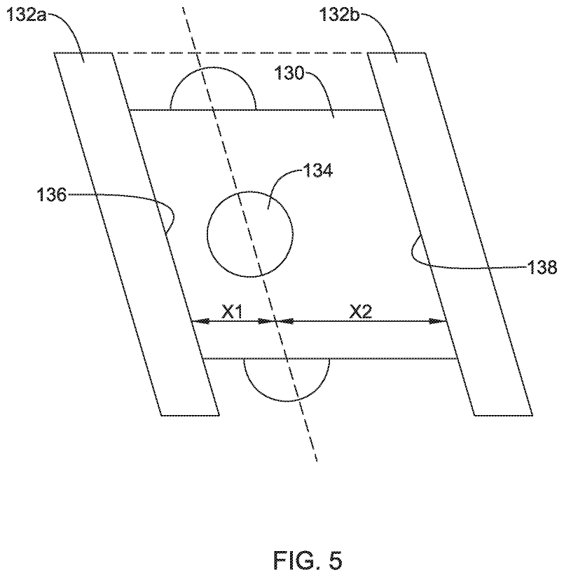

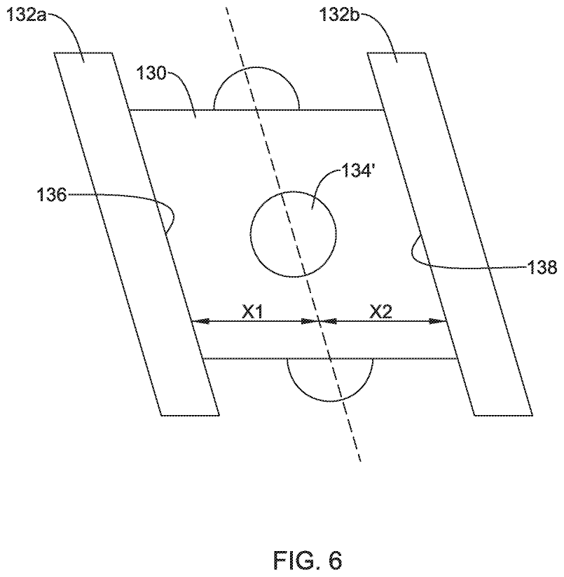

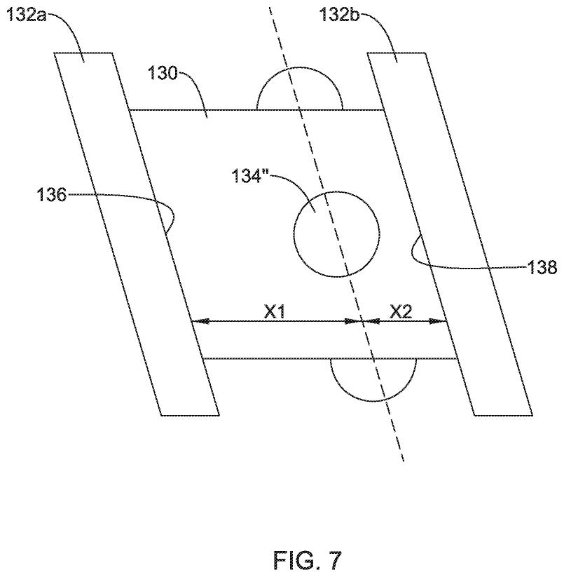

The dome members 134 may be arranged in variety of manners. For example, in some instances, the dome members 134 may be disposed midway between adjacent windings of the helical thread 132. In some instances, the dome members 134 maybe arranged closer to one winding of the helical thread 132 as shown in FIG. 5. For example, the helical thread 132 may include a first winding 132a having a downstream facing surface 136 and a second winding 132b having an upstream facing surface 138. A line L passing through the center of the dome members 134 may be spaced a distance X1 from the downstream facing surface 136. The line L passing through the center of the dome members 134 may be spaced a distance X2 from the upstream facing surface 138. In some instances, distance X1 is smaller than distance X2. This, however, is not intended to be limiting. For example, FIG. 6 illustrates dome members 134′ that are equally spaced between the downstream facing surface 136 and the upstream facing surface 138. In this example, distance X1 is equal to distance X2. Furthermore, FIG. 7 illustrates dome members 134″ that are arranged closer to the upstream facing surface 138 than the downstream facing surface 136. In this example, distance X1 is larger than distance X2.

In some instances, the thread 132 may project radially outward from the screw root 130 a first distance and the dome members 134 may project radially outward from the screw root 130 a second distances. In some instances, the first distance may equal the second distance. In other instances, first distance is greater than the second distance. In some instances, the thread 132 projects radially outward so that the thread is disposed adjacent to or contacts the inner surface of the barrel 116 and the dome members 134 may be spaced from the inner surface of the barrel 116. Furthermore, systems are contemplated that include dome members 134 that project out differing distances.

In some instances, the dome members 134 are disposed along only the metering zone C. However, this is not intended to be limiting. In some instances, the dome members 134 may be disposed along the feed zone A, the transition zone, B, the metering zone C, and/or any combination thereof. For example, FIG. 3 depicts an example dome member 134a in phantom line to illustrate that the feed zone A may include one or more dome members 134/134a. FIG. 3 also depicts an example dome member 134b in phantom line to illustrate that the transition zone B may include one or more dome members 134/134b. In addition, any of the feed zone A, the transition zone, B, and/or the metering zone C may be free of dome members 134.

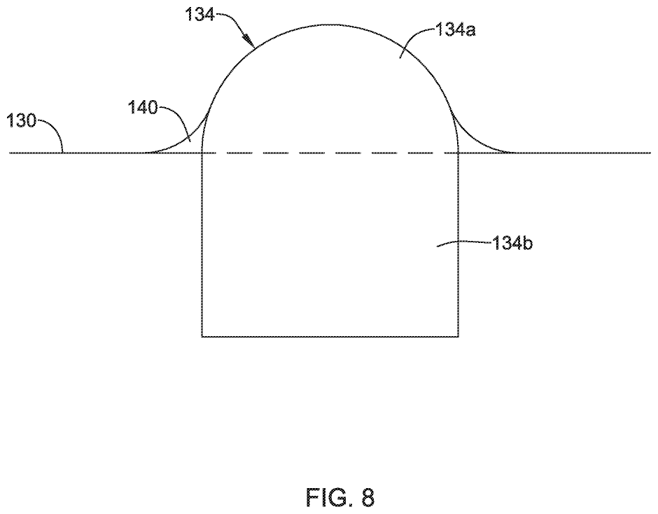

FIG. 8 illustrates that the dome member 134 may be partially embedded within the screw root 130. For example, a domed portion 134a of the dome member 134 may project radially outward from the screw root 130 and a base portion 134b of the dome member 134 may be embedded within the screw root 130. A weld 140 may be disposed at the interface of the dome member 134 and the screw root 130.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The invention's scope is, of course, defined in the language in which the appended claims are expressed.

What is claimed is:

1. A system for molding products that include long fiber thermoplastic materials, the system comprising:
a barrel;
a hopper in communication with the barrel;
a screw disposed within the barrel, the screw being designed to rotate and reciprocate within the barrel;
wherein the screw includes a metering section; and
a plurality of dome members coupled to the screw and disposed along the metering section.

2. The system of claim 1, wherein the screw includes a root and a helical thread disposed about the root.

3. The system of claim 2, wherein at least some of the plurality of dome members are disposed between adjacent windings of the helical thread.

4. The system of claim 2, wherein at least some of the plurality of dome members are disposed symmetrically relative to the helical thread.

5. The system of claim 2, wherein at least some of the plurality of dome members are positioned midway between adjacent windings of the helical thread.

6. The system of claim 2, wherein at least some of the plurality of dome members are disposed asymmetrically relative to the helical thread.

7. The system of claim 2, wherein the helical thread includes a first winding and a second winding adjacent to the first winding, wherein the first winding includes a first edge facing downstream, wherein the second winding includes a second edge facing upstream, and wherein at least some of the plurality of dome members are disposed closer to the first edge than to the second edge.

8. The system of claim 2, wherein the root has a first root diameter at the metering section and a second root diameter at a feed region, the second root diameter being different than the first root diameter.

9. The system of claim 2, wherein the helical thread projects a first distance radially outward from the root, wherein at least some of the plurality of dome members project a second distance radially outward from the root, and wherein the first distance is greater than the second distance.

10. The system of claim 1, wherein the screw is free of helical thread.

11. The system of claim 1, wherein the screw includes a discontinuous thread.

12. The system of claim 1, wherein the screw is designed to translate within the barrel.

13. The system of claim 1, wherein the screw includes a feed section and a transition section.

14. The system of claim 13, further comprising one or more additional dome members disposed along the feed section.

15. The system of claim 13, wherein the feed section is free of dome members.

16. The system of claim 13, further comprising one or more additional dome members disposed along the transition section.

17. The system of claim 13, wherein the transition section is free of dome members.

18. A system for molding products, the system comprising:
a barrel containing a resin and a plurality of fibers;
wherein the resin includes a thermoplastic resin;
wherein at least some of the plurality of fibers include fibers having a length of at least 6 millimeters;
a screw disposed within the barrel, the screw including a screw root and a helical flight disposed about the screw root;
wherein the screw is designed to rotate and reciprocate within the barrel;
wherein the screw includes a feed zone, a transition zone, and a metering zone; and
a plurality of dome members coupled to the screw and disposed along the metering zone.

19. The system of claim 18, wherein at least some of the plurality of fibers include fibers having a length of about 6-12 millimeters.

20. A system for molding products that include long fiber thermoplastic materials, the system comprising:
a barrel;
a hopper in communication with the barrel;
a screw disposed within the barrel, the screw being designed to rotate and translate/reciprocate within the barrel;
wherein the screw includes a metering section; and
a plurality of dome members coupled to the screw and disposed along the metering section.
